(19) United States
(12) Patent Application Publication
(10) Pub. No.: US 2003/0182665 A1
(43) Pub. Date: Sep. 25, 2003

(54) Apparatus and method for managing cable modem based on web

(76) Inventor: Se-Oh Kwon, Suwon-shi (KR)

Correspondence Address: Robert E. Bushnell, Suite 300, 1522 K Street, N.W., Washington, DC, 20005, US

(21) Appl. No.: 10/352,156

(22) Filed: Jan. 28, 2003

(30) Foreign Application Priority Data
Mar. 20, 2002 (KR) 2002-14962

(51) Int. Cl. H04N 7/173

(52) U.S. Cl. 725/111; 725/112

(57) ABSTRACT

An apparatus and method for managing a cable modem using a Web server are disclosed. The cable modem, which includes the Web server, enables an Internet connection of a user computer by connecting the user computer to a cable television line. The cable modem is enabled to communicate with the user computer on which a Web browser is mounted. If the Web server receives a request for management information associated with an operation of the cable modem from the Web browser, the Web server then transmits the management information to the Web browser in response to the management information request. Further, if the Web server receives a setup request for operation parameters associated with an operation of the cable modem from the Web browser, the Web server then transfers the operation parameter setup request to a controller managing the operation parameters in response to the operation parameter setup request. Furthermore, if a dynamic host configuration protocol (DHCP) server mounted on the cable modem receives an Internet address assignment request, it assigns the Internet address to the computer on which the Web browser is mounted. Therefore, the apparatus can directly manage the cable modem without using an additional management protocol.

### CLAIM OF PRIORITY

This application makes reference to, incorporates the same herein, and claims all benefits accruing under 35 U.S.C. §119 from my application “APPARATUS AND METHOD FOR MANAGING CABLE MODEM BASED ON WEB filed with the Korean Industrial Property Office on Mar. 20, 2002 and there duly assigned Serial No. 2002-14962.

### BACKGROUND OF THE INVENTION

1. Technical Field

The present invention relates to a cable modem and, more particularly, to an apparatus and method for managing the cable modem and setting up operation parameters.

2. Related Art

A television cable line can be installed into a building such as a house, apartment building, or office building. Typically, the cable line is connected to a set-top box in the building, and then a television is connected to the set-top box, so that the cable line provides video and audio programs to the television. A personal computer (PC) can be connected to the television cable line to communicate with the Internet. The personal computer is not connected directly to the television cable line. The personal computer is connected to a cable modem, and the cable modem is connected to the television cable line.

The cable modem enables data communications at a maximum bit rate of about 10 megabits per second (Mbps). When a cable modem is used to connect a personal computer to a cable television line, a viewer can watch programs received from the television cable line and a user can access the Internet through the television cable line.

When a cable modem is installed, an operation for managing or controlling the cable modem is accomplished only when the cable modem is able to perform Internet communications normally, because the management of the cable modem is performed through the Internet and the television cable line. If the cable modem cannot be connected to the Internet because of an abnormal operation of the cable modem, then it is not possible that the operation parameters of the cable modem can be set up, and it is not possible to collect management information. In other words, an access to the cable modem is typically possible only through the Internet.

When there is a problem during the initial installation of the cable modem, a manager cannot identify the current state of the cable modem or network. Further, where another problem is caused while the cable modem is operated, the manager or an operator cannot identify the operating state of the cable modem and cannot change the operation parameters needed to resolve the problem if the access to the cable modem through the Internet is not possible.

It appears that the typical method for managing a cable modem cannot actively resolve the problems caused in the cable modem and cannot remotely change the operation parameters of the cable modem. Efforts have been made to improve cable modems and related equipment.

Exemplars of recent efforts in the art include Request for Comments (RFC) 2669 entitled DOCSIS CABLE DEVICE MIB CABLE DEVICE MANAGEMENT INFORMATION BASE FOR DOCSIS COMPLIANT CABLE MODEMS AND CABLE MODEM TERMINATION SYSTEMS, by M. St. Johns @Home Network, August 1999, Request for Comments (RFC) 2670 entitled RADIO FREQUENCY (RF) INTERFACE MANAGEMENT INFORMATION BASE FOR MCNS/DOCSIS COMPLIANT RF INTERFACES, by M. St. Johns @Home Network, August 1999, U.S. Pat. No. 6,023,464 to Woundy, entitled AUTO-PROVISIONING OF USER EQUIPMENT, issued on Feb. 8, 2000, U.S. Pat. No. 6,049,826 to Beser, entitled METHOD AND SYSTEM FOR CABLE MODEM INITIALIZATION USING DYNAMIC SERVERS, issued on Apr. 11, 2000, U.S. Pat. No. 6,286,058 to Hrastar et al., entitled APPARATUS AND METHODS FOR AUTOMATICALLY REROUTING PACKETS IN THE EVENT OF A LINK FAILURE, issued on Sep. 4, 2001, and U.S. Pat. No. 6,393,478 to Bahlmann, entitled CABLE MODEM AND PERSONAL COMPUTER TROUBLESHOOTING TOOL, issued on May 21, 2002.

While these recent efforts provide advantages, I note that they fail to adequately provide an apparatus and method for efficiently and conveniently managing a cable modem.

### SUMMARY OF THE INVENTION

Therefore, the present invention has been made in view of the above problems, and it is an object of the present invention to provide an apparatus and method for embedding a Web server within a cable modem and monitoring management information of the cable modem through a Web browser mounted within a user computer.

It is another object of the present invention to provide an apparatus and method for embedding a Web server within a cable modem and setting up operation parameters of the cable modem through a Web browser mounted within a user computer.

It is yet another object of the present invention to provide an apparatus and method for setting up operation parameters of the cable modem through a Web browser mounted within a user computer in the case that the cable modem is not operated normally.

In accordance with one aspect of the present invention, the above and other objects can be accomplished by the provision of an apparatus for enabling an Internet connection of a user computer by connecting the user computer to a cable television line and managing a cable modem communicating with the user computer within which a Web browser is mounted, the apparatus comprising: a controller for managing and setting up management information and operation parameters associated with an operation of the cable modem; and a Web server for transmitting the management information provided from the controller to the Web browser in response to a management information request from the Web browser mounted within the user computer and for transferring an operation parameter setup request from the Web browser to the controller; the controller changing and setting up the operation parameters of the cable modem in response to the operation parameter setup request.

In accordance with another aspect of the present invention, there is provided a method for enabling an Internet connection of a user computer by connecting the user computer to a cable television line and managing a cable modem communicating with the user computer within which a Web browser is mounted, the method comprising the steps of: a) allowing a Web server mounted within the cable modem to receive a request for management information associated with an operation of the cable modem from the Web browser mounted within the user computer; b) allowing the Web server to transmit the management information to the Web browser in response to the management information request; c) allowing the Web server mounted within the cable modem to receive a setup request for operation parameters associated with the operation of the cable modem from the Web browser; and d) allowing the Web server to transfer the operation parameter setup request to a controller mounted within the cable modem and managing the operation parameters in response to the operation parameter setup request.

To achieve these and other objects in accordance with the principles of the present invention, as embodied and broadly described, the present invention provides an apparatus for managing and controlling a cable modem to enable a computer system to establish an Internet connection, the apparatus comprising: a cable modem being in communication with a Web browser of a computer system; a controller managing and setting up management information and operation parameters for operation of said cable modem, said controller being in communication with said cable modem; and a Web server being connected to said controller, said Web server transmitting the management information provided from said controller to the Web browser in response to a management information request from the Web browser, said Web server transferring an operation parameter setup request from the Web browser to said controller; said controller changing and setting up the operation parameters of said cable modem in response to the operation parameter setup request.

To achieve these and other objects in accordance with the principles of the present invention, as embodied and broadly described, the present invention provides a method for managing and controlling a cable modem to enable a computer system to establish an Internet connection, the method comprising: sending a first request from a Web browser in a computer system to a Web server in a cable modem, the first request requesting management information associated with an operation of the cable modem; transmitting the management information from the Web server to the Web browser in response to the management information request; sending a setup request from the Web browser to the Web server, the setup request requesting operation parameters associated with the operation of the cable modem; transfering the setup request from the Web server to a controller mounted in the cable modem; and managing the operation parameters in response to setup request.

To achieve these and other objects in accordance with the principles of the present invention, as embodied and broadly described, the present invention provides a method for managing and controlling a cable modem to enable a computer system to establish an Internet connection, the method comprising: transmitting an Internet address assignment request from a computer system to a cable modem; assigning an uncertified Internet address on the Internet to the computer system, said assigning being performed by the cable modem; connecting a Web browser mounted in the computer system to a Web server mounted in the cable modem based on the assigned uncertified Internet address; transmitting transmit a setup request from the Web browser to the Web server, the setup request requesting operation parameters for operation of the cable modem; changing and setting up the operation parameters in response to the operation parameter setup request, said changing and setting up being performed by the cable modem; transmitting a change and setup result through the Web server to the Web browser; and displaying the change and setup result, said displaying being performed by the Web browser and the computer system.

The present invention is more specifically described in the following paragraphs by reference to the drawings attached only by way of example. Other advantages and features will become apparent from the following description and from the claims.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention.

FIG. 1 is a view showing a configuration of a cable network;

FIG. 2 is a view showing a flow of messages to be used for managing a cable modem using an simple network management protocol (SNMP);

FIG. 3 is a block diagram showing an apparatus for managing a cable modem, in accordance with the principles of the present invention;

FIG. 4 is a view explaining an operation for managing the cable modem where it is operated normally, in accordance with the principles of the present invention;

FIG. 5 is a view explaining an operation for managing the cable modem where it is not operated normally, in accordance with the principles of the present invention;

FIG. 6 is an exemplary view showing an initial screen to be displayed by a Web browser of a user computer, in accordance with the principles of the present invention; and

FIG. 7 is an exemplary view showing a screen for setting up operation parameters of a cable modem to be displayed by a Web browser mounted within a user computer, in accordance with the principles of the present invention.

### DETAILED DESCRIPTION OF THE PREFERRED EMBODIMENTS

While the present invention will be described more fully hereinafter with reference to the accompanying drawings, in which preferred embodiments of the present invention are shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

Illustrative embodiments of the invention are described below. In the interest of clarity, not all features of an actual implementation are described. In the following description, well-known functions, constructions, and configurations are not described in detail since they could obscure the invention with unnecessary detail. It will be appreciated that in the development of any actual embodiment numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill having the benefit of this disclosure.

An operation principle in preferred embodiments of the present invention will be described in detail with reference to the annexed drawings. In the following description, a detailed description of known functions and configurations incorporated herein will be omitted when it may make the subject matter of the present invention rather unclear. Further, terms to be described below are defined according to functions in the present invention. The terms can be varied by an intention or practice of a user or operator. Accordingly, the term definition should be determined on the basis of the following description.

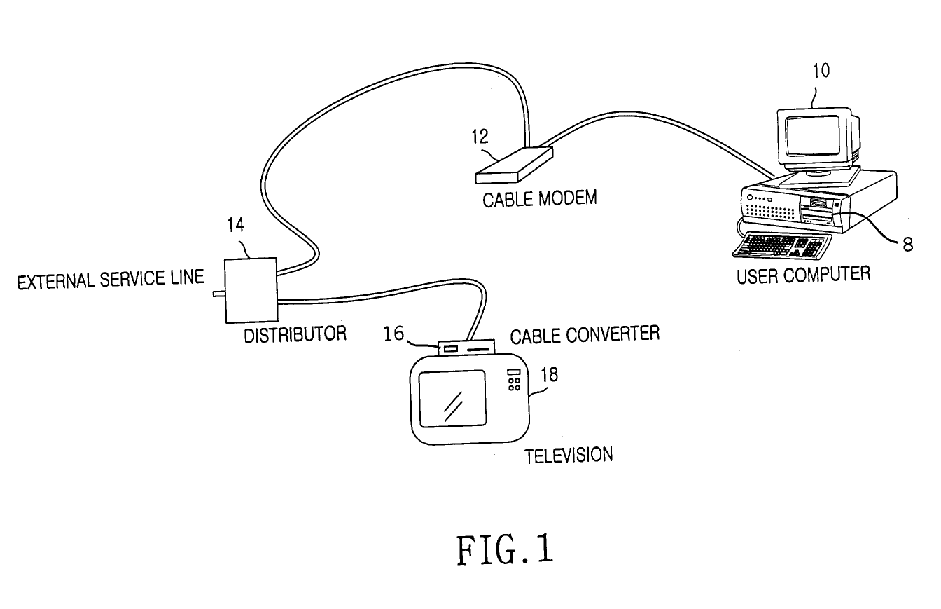

FIG. 1 is a view showing a configuration of a cable network. Regarding line cables for a computer connection, one line cable is distributed to a cable converter (the set-top box) 16 connected to a television 18 by a distributor 14 and the other line cable is distributed to a cable modem 12 connected to a user computer 10 by the distributor 14. The cable modem 12 is connected to a network interface card, for example, a standard 10 Base-T Ethernet card, within the user computer 10. The user computer 10 has access to a memory unit 8 that stores data. The memory unit 8 can be a hard disk drive, a compact disc (CD), a floppy diskette, a read only memory (ROM), or other type of memory unit for storing data.

All cable modems should be connected to a coaxial cable of a cable broadcasting station to communicate with a cable modem termination system (CMTS) located at the cable broadcasting station. One television channel for downstream, to be directed to subscribers from the cable broadcasting station, is employed between the cable modems and the cable modem termination system (CMTS). Another television channel for upstream, to be directed to the cable broadcasting station from the subscribers, is employed between the cable modems and the cable modem termination system (CMTS).

The cable modem termination system (CMTS) converts a signal from a cable modem into an Internet protocol (IP) packet to transmit the IP packet to the Internet over an IP router. Further, the signal to be transmitted to the cable modem is modulated to a downstream signal to be transmitted over the cable by the cable modem termination system (CMTS).

The cable modem is installed so that it can be connected to the user computer and the television by a standard or conventional Internet service provider. At initial installation, the cable modem is connected to the cable modem termination system (CMTS) over the Internet and sets up various operation parameters, for example, an upstream frequency, a downstream frequency, a channel setup, a signal to noise ratio (SNR), and others. It is determined whether the cable modem is operating normally. In more detail, the cable modem tries to receive an Internet protocol (IP) packet from the cable modem termination system (CMTS) over various available frequencies after the cable modem is connected to the cable. If the cable modem receives the Internet protocol (IP) packet normally, it sets up a corresponding frequency to initiate Internet services.

After the cable modem is installed normally and the Internet services are initiated, the Internet service provider should continuously monitor the cable modem so that the Internet services can be provided to users. A method for managing the cable modem employs a simple network management protocol (SNMP). The method is a network management method based on a transmission control protocol/Internet protocol (TCP/IP). Here, a unique Internet protocol (IP) address is assigned to the cable modem. Further, it is determined whether the cable modem can transmit and receive data over a network normally so that a current state of the cable modem can be managed.

The simple network management protocol (SNMP) is a network management protocol in a transmission control protocol/Internet protocol (TCP/IP) environment. Here, an SNMP agent is mounted on equipment, that is, a network device, requiring continuous management like the cable modem on the Web. A remote manager can monitor operating states port by port. Such an SNMP provides connectionless services using a control-command protocol data unit (PDU). The control-command protocol data unit (PDU) is transmitted over authentication services. The control-command PDU is transmitted in a form of a message using a user datagram protocol (UDP).

The simple network management protocol (SNMP) manages a network basically using five control-command protocol data units (PDUs). The five control-command PDUs include “Get-Request”, “Get-Next-Request”, “Set-Request”, “Get-Response” and “Trap”.

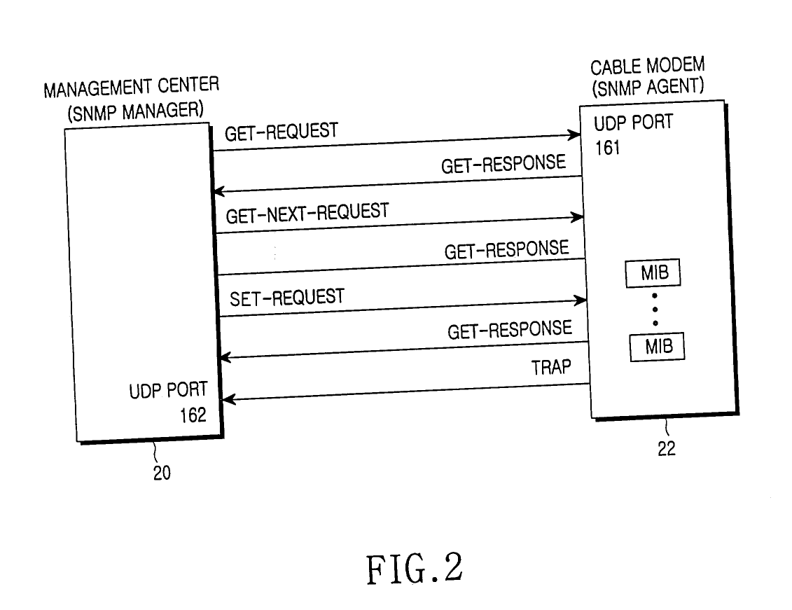

FIG. 2 is a view showing a flow of messages to be used for managing a cable modem using an simple network management protocol (SNMP). As shown in FIG. 2, an SNMP manager 20 is equipped with a management center on a network. A simple network management protocol (SNMP) agent 22 is equipped with the cable modem. The messages exchanged between the SNMP manager 20 and the SNMP agent 22 are transmitted and received over prescribed user datagram protocol (UDP) ports, including a UDP port 162 coupled to the SNMP manager 20 and a UDP port 161 coupled to the SNMP agent 22.

Referring to FIG. 2, the simple network management protocol (SNMP) manager 20 transmits a “Get-Request” message to get a value of particular management information located in the simple network management protocol (SNMP) agent 22. Then, the SNMP agent 22 transmits a “Get-Response” message to send the requested value in response to the “Get-Request” message from the SNMP manager 20. Further, the SNMP manager 20 transmits a “Get-Next-Request” message to the SNMP agent 22 to get a value next to a predetermined value of an object specified by the SNMP manager 20 or an index next to a predetermined index where the specified object is a table. Then, the SNMP agent 22 transmits a “Get-Response” message in response to the “Get-Next-Request” message.

Furthermore, the simple network management protocol (SNMP) manager 20 transmits a “Set-Request” message to the simple network management protocol (SNMP) agent 22 to request a change and setup for values associated with a particular object belonging to the SNMP agent 22. Then, the SNMP agent 22 transmits another “Get-Response” message to the SNMP manager 20 in response to the “Set-Request” message. If a particular error occurs in the SNMP agent 22 or the transmission of a response message to a request message is delayed, the SNMP agent 22 transmits a “trap” message to inform the SNMP manager 20 of the fact that the particular error occurs or the transmission of the response message is delayed.

The management information is managed in a form of an management information base (MIB) within the simple network management protocol (SNMP) agent 22. The management information base (MIB) is a small tree form of a structural database storing information to be managed on the basis of the SNMP. A structure of management information (SMI) describes objects included in the MIB and defines formats of messages to be transmitted.

The cable network described above, with reference to FIGS. 1 and 2, can recognize the current state of the cable modem by reading a particular management information base (MIB) (RFC 2669, 2670) as well as a general management information base (MIB) of general network information associated with the cable modem. The Request for Comments (RFC) 2669 entitled DOCSIS CABLE DEVICE MIB CABLE DEVICE MANAGEMENT INFORMATION BASE FOR DOCSIS COMPLIANT CABLE MODEMS AND CABLE MODEM TERMINATION SYSTEMS, by M. St. Johns @Home Network, August 1999, and the Request for Comments (RFC) 2670 entitled RADIO FREQUENCY (RF) INTERFACE MANAGEMENT INFORMATION BASE FOR MCNS/DOCSIS COMPLIANT RF INTERFACES, by M. St. Johns @Home Network, August 1999, both pertain to this issue.

However, in the cable network described above with reference to FIGS. 1 and 2, an operation for managing the cable modem is only accomplished when the cable modem successfully performs Internet communications or performs Internet communciations normally. If the cable modem cannot be connected to the Internet because of an abnormal operation of the cable modem, it is impossible for the operation parameters to be set up, and it is impossible for the management information to be collected. In other words, an access to the cable modem is typically possible through only the Internet. When there is a problem at the initial installation of the cable modem, a manager cannot identify the current state of the cable modem or network. Further, where another problem is caused while the cable modem is being operated, the manager or an operator cannot identify the operating state of the cable modem and cannot change the operation parameters needed to resolve the problem if the access to the cable modem through the Internet is impossible.

The method for managing the cable modem, as discussed above with reference to FIGS. 1 and 2, cannot actively resolve problems caused in the cable modem and cannot remotely change the operation parameters of the cable modem.

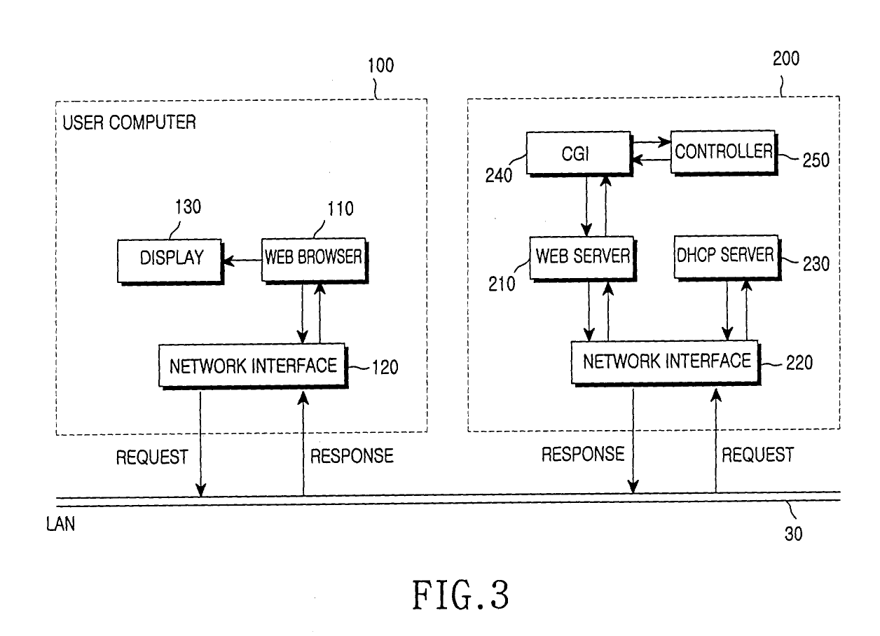

FIG. 3 is a block diagram showing an apparatus for managing a cable modem, in accordance with the principles of the present invention. The FIG. 3 shows an apparatus for controlling and managing a cable modem. An apparatus in accordance with the present invention is associated with a web-based management system (WMS) for managing a cable modem based on the World Wide Web. The apparatus in accordance with the present invention includes a Web server, which can provide Web documents to the cable modem. Commands for controlling and managing the cable modem are inputted in a form of a Web document using a Web browser mounted within a user computer. In response to the commands, the cable modem can change operation parameters or transmit requested management information.

The cable modem searches for particular operation parameters to be provided from an Internet service provider and matches its own parameters to the particular operation parameters. The particular operation parameters include a downstream frequency, a downstream modulation scheme, an upstream frequency, an upstream modulation scheme, and others, for example. If the cable modem is not operating normally, the operation parameters of the Internet service provider can be changed when the cable modem is installed or during the abnormal operations of the cable modem. At this time, if history information searched at initial installation of the cable modem does not remain and Internet service providers exist in the same network, it takes a lot of time to initialize the cable modem because the cable modem should search for the operation parameters corresponding to the respective Internet service providers.

In accordance with the present invention, the time needed to initialize the cable modem can be dramatically reduced so that the user computer can directly set up the operation parameters of the cable modem. The operation parameters of the cable modem can include a downstream frequency, an upstream channel identifier (ID), and others, for example. Similarly, where the operation parameters of the Internet service provider are changed while the cable modem is operated normally, the user computer can set up the operation parameters through the Web browser.

Referring to FIG. 3, a user computer 100 can be a computer system such as a personal computer (PC), a desktop computer, a workstation, a server, a portable computer, a notebook computer, a hand-held computer, a palm-sized computer, a wearable computer, or any other type of computer system. The user computer 100 can execute a Web browser 110 capable of being connected to the Internet. The Web browser 110 can be Microsoft Internet Explorer™, Netscape Navigator™ or other browser. The Microsoft Internet Explorer™ Web browser and the Netscape Navigator™ Web browser are Web browser software applications, and are well known to those in the art. The Web browser 110 can be connected to a Web server 210 connected to the Internet to receive a Web document from the Web server 210. The received Web document is outputted to a display unit 130.

The user computer 100 is connected to a local area network (LAN) 30 using an internal network interface card 120. The local area network (LAN) 30 connects the user computer 100 to a communication network such as the Internet or etc. through a cable modem 200. The cable modem 200 is connected to a cable modem termination system (CMTS) through a cable network. The cable modem 200 has an interface configuration to be connected to the cable modem termination system (CMTS). However, a detailed description of the interface configuration will be omitted since it is not directly associated with the subject matter of the present invention.

The cable modem 200 includes the Web server 210 capable of receiving and transmitting Web documents from and to the Web browser 110 through the Internet so that the user computer 100 can perform state management and parameter setup. Here, the Web documents are created with a special language such as a hyper text markup language (HTML) to be used on the Internet and transferred through a special protocol such as a hyper text transfer protocol (HTTP).

A controller 250 controls the cable modem 200. A major function of the controller 250 is to detect a downstream Internet packet from a downstream frequency signal and convert an upstream Internet packet into an upstream frequency signal. The controller 250 acts as a bridge to transfer the downstream and upstream Internet packets between the cable modem termination system (CMTS) and the user computer 100.

The Web server 210 is connected to the controller 250 through a common gateway interface (CGI) 240 so that a request from the user computer 100 (that is, a Web user) received through the Web browser 110 can be transferred to the controller 250 and requested data can be transferred to the user computer 100 in response to the request. The common gateway interface (CGI) 240 acts as a standard interface for calling the controller 250 being an application program, transferring input parameters and receiving a result, in place of the Web server 210.

For example, if the Web user requests information indicating a frequency used in the cable modem 200 in order to identify the use frequency, the cable modem 200 calls the controller 250 through the common gateway interface (CGI) 240 in response to the request of the Web user. In response to the call, the controller 250 transfers the frequency information to be maintained and managed by its own controller to the common gateway interface (CGI) 240. The common gateway interface (CGI) 240 transfers the frequency information to the Web server 210. Then, the Web server 210 creates a hyper text markup language (HTML) Web document with the frequency information to provide the hyper text markup language (HTML) Web document to the Web user.

For another example, if the Web user inputs a desired command on a Web page or selects a menu and informs the Web server 210 of the inputted command or the selected menu, the common gateway interface (CGI) 240 converts it into a predetermined format to transfer the predetermined format of information to the controller 250. In response to the command, the controller 250 performs work such as changing corresponding operation parameter setup, for example. The controller 250 provides a performed work result to the Web server 210 through the common gateway interface (CGI) 240. The Web server 210 transmits the performed work result to the Web user.

The Web browser 110 and Web server 210 have unique Internet protocol (IP) addresses so that they can be connected to each other. Conventionally, the cable modem 200 has an Internet protocol (IP) address. Where the cable modem 200 is connected to the Internet through the cable network normally, the Internet service provider can assign a certified Internet protocol (IP) address to the user computer 100. Here, the certified Internet protocol (IP) address means an Internet protocol (IP) address available on the Internet.

However, where the cable modem 200 is not operated normally, the Internet protocol (IP) address cannot be assigned to the user computer 100. To resolve this problem, a dynamic host configuration protocol (DHCP) server 230 is embedded in the cable modem 200. The dynamic host configuration protocol (DHCP) server 230 is also known as an address assigner because it can assign an address, as explained below.

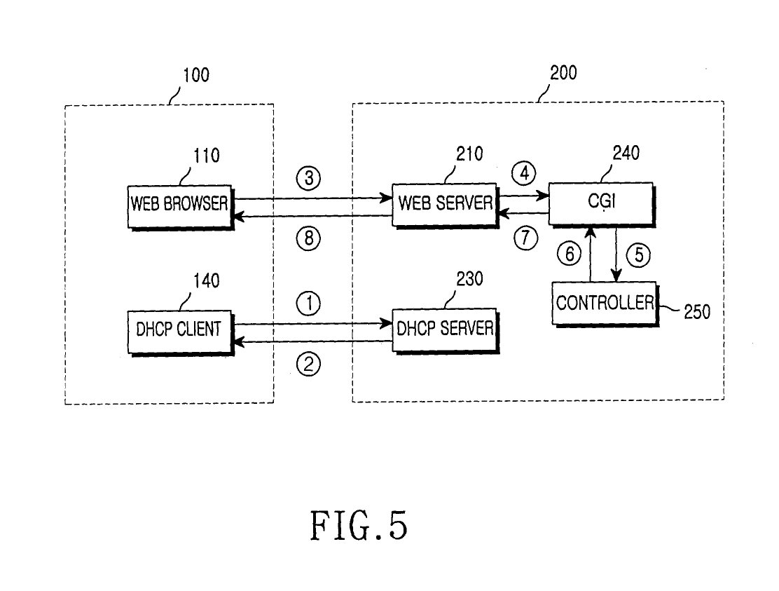

In response to an Internet protocol (IP) assignment request from the user computer 100, the dynamic host configuration protocol (DHCP) server 230 of the cable modem 200 assigns an uncertified dynamic Internet protocol (IP) address to the user computer 100. Here, the uncertified dynamic Internet protocol (IP) address indicates an Internet protocol (IP) address, which can be available or unavailable on the Internet. The user computer 100 includes a dynamic host configuration protocol (DHCP) client, which can be connected to the dynamic host configuration protocol (DHCP) server 230. The FIG. 5 shows dynamic host configuration protocol (DHCP) client 240 in user computer 100.

If the dynamic host configuration protocol (DHCP) server 230 is continuously operated when the cable modem 200 returns to a normal operating state, the user computer 100 cannot use the Internet because the uncertified Internet protocol (IP) address is assigned to the user computer 100. Accordingly, if the cable modem 200 returns to the normal operating state, it should receive the certified Internet protocol (IP) address to be assigned from another dynamic host configuration protocol (DHCP) server provided by the Internet service provider. When the cable modem 200 is operated normally, the dynamic host configuration protocol (DHCP) server 230 is stopped. Here, the dynamic host configuration protocol (DHCP) server 230 limits an available period of the uncertified Internet protocol (IP) address assigned to the user computer 100. For example, the available period is limited to 30 seconds.

When the available period expires, the dynamic host configuration protocol (DHCP) client within the user computer 100 transmits an Internet protocol (IP) address assignment request message to the cable modem 200. At this time, because the dynamic host configuration protocol (DHCP) server 230 within the cable modem 200 is not operated, the message is transferred to another dynamic host configuration protocol (DHCP) server provided by the Internet service provider. Accordingly, the user computer 100 can receive the certified Internet protocol (IP) address from another dynamic host configuration protocol (DHCP) server provided by the Internet service provider.

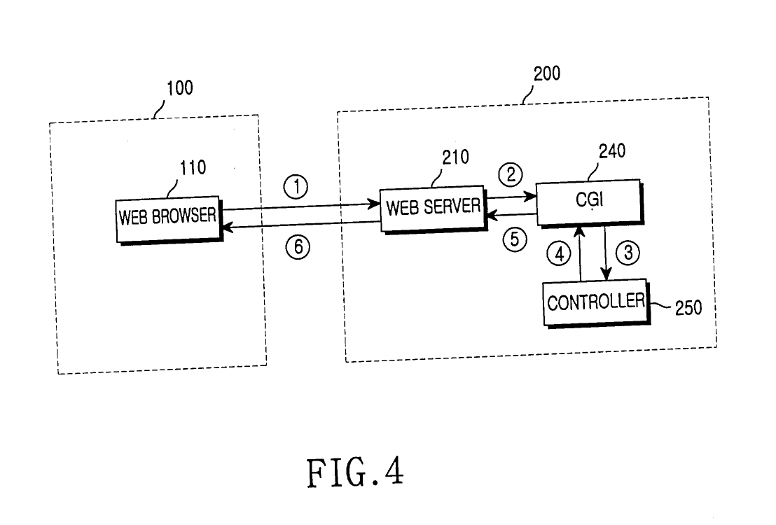

FIG. 4 is a view explaining an operation for managing the cable modem where it is operated normally, in accordance with the principles of the present invention. The case that the cable modem 200 is operated normally will be described below with reference to FIG. 4.

Where the cable modem 200 is installed for the first time to be connected to the user computer 100 or to be operated normally, the Web server 210 opens 80 ports and waits for a hyper text transfer protocol (HTTP) request message. Here, the hyper text transfer protocol (HTTP) request message is a message having a form of a Web document needed for requesting the operation parameters of the cable modem 200, which are currently set, and management information or for requesting a change and setup of operation parameters, which are currently set. The operation parameters of the cable modem 200 can be, for example, an upstream frequency, a downstream frequency, a channel setup, a signal to noise ratio (SNR), and others. The requested management information can include error information, for example.

If the user computer 100 transmits a hyper text transfer protocol (HTTP) request message through the Web browser 110 (at \mathring{1} shown in FIG. 4), the Web server 210 calls the controller 250 through the common gateway interface (CGI) 240 to identify the management information of the cable modem 200 after receiving and analyzing the hyper text transfer protocol (HTTP) request message (at \mathring{2} and \mathring{3} shown in FIG. 4). In response to the call, the controller 250 processes the hyper text transfer protocol (HTTP) request message to transfer the management information of the cable modem 200 to the common gateway interface (CGI) 240. Then, the common gateway interface (CGI) 240 transmits the management information to the Web server 210. Alternatively, the controller 250 performs the change of the operation parameters of the cable modem 200 received from the Web browser 110 of the user computer 100 and transfers a performance result to the Web server 210 through the common gateway interface (CGI) 240 (at \mathring{4} and \mathring{5} shown in FIG. 4).

The Web server 210 processes the management information or performance result to create a hyper text markup language (HTML) Web document and transmits the hyper text markup language (HTML) Web document to the Web browser 110 through the hyper text transfer protocol (HTTP) (at \mathring{6} shown in FIG. 4). The Web browser 110 displays the hyper text markup language (HTML) Web document. Accordingly, a user can search for the operation parameters of the cable modem 200, which are currently set, or change and set up the operation parameters of the cable modem 200 through the user computer 100.

FIG. 5 is a view explaining an operation for managing the cable modem where it is not operated normally, in accordance with the principles of the present invention. The case that the cable modem 200 is not operated normally will be described with reference to FIG. 5.

If the cable modem 200 cannot be connected to the Internet due to an error, the user computer 100 transmits a dynamic host configuration protocol (DHCP) assignment request message to the cable modem 200 through a dynamic host configuration protocol (DHCP) client 140 within the user computer 100 (at \mathring{1} shown in FIG. 5). Then, the dynamic host configuration protocol (DHCP) assignment request message is processed in the dynamic host configuration protocol (DHCP) server 230 located within the cable modem 200. The dynamic host configuration protocol (DHCP) server 230 selects an Internet protocol (IP) address for the user computer 100 within a predetermined Internet protocol (IP) address assignment range and transmits a dynamic host configuration protocol (DHCP) assignment response message including the selected Internet protocol (IP) address to the dynamic host configuration protocol (DHCP) client 140 of the user computer 100 (at \mathring{2} shown in FIG. 5).

Where the Web server 210 opens 80 ports and waits for a hyper text transfer protocol (HTTP) request message. Here, the hyper text transfer protocol (HTTP) request message is a message having a form of a Web document needed for requesting the operation parameters of the cable modem 200 and management information or for requesting a change of operation parameters, which are currently set. The operation parameters of the cable modem 200 can be, for example, an upstream frequency, a downstream frequency, a channel setup, a signal to noise ratio (SNR), and others. The requested management information can include error information, for example.

The user computer 100 is connected to the Web server 210 through the Web browser 110 and transmits the hyper text transfer protocol (HTTP) request message to the Web server 210 through the Web browser 110 (at \mathring{3} shown in FIG. 5). The Web server 210 calls the controller 250 through the common gateway interface (CGI) 240 after receiving and analyzing the hyper text transfer protocol (HTTP) request message (at \mathring{4} and \mathring{5} shown in FIG. 5). In response to the call, the controller 250 processes the hyper text transfer protocol (HTTP) request message to transfer a process result to the common gateway interface (CGI) 240. Then, the common gateway interface (CGI) 240 transmits the process result to the Web server 210. Alternatively, the controller 250 performs a change of operation parameters of the cable modem 200 and transfers a performance result to the Web server 210 through the common gateway interface (CGI) 240 (at \mathring{6} and \mathring{7} shown in FIG. 5).

The Web server 210 processes the process or performance result to create a hyper text markup language (HTML) Web document and transmits the hyper text markup language (HTML) Web document to the Web browser 110 through the hyper text transfer protocol (HTTP) (at \mathring{8} shown in FIG. 5). The Web browser 110 displays the hyper text markup language (HTML) Web document.

Accordingly, where the cable modem 200 is not operated, an operation of the cable modem 200 can be initiated by allowing a user to search for the operation parameters of the cable modem 200, which are currently set, or change and set up the operation parameters of the cable modem 200 through the user computer 100.

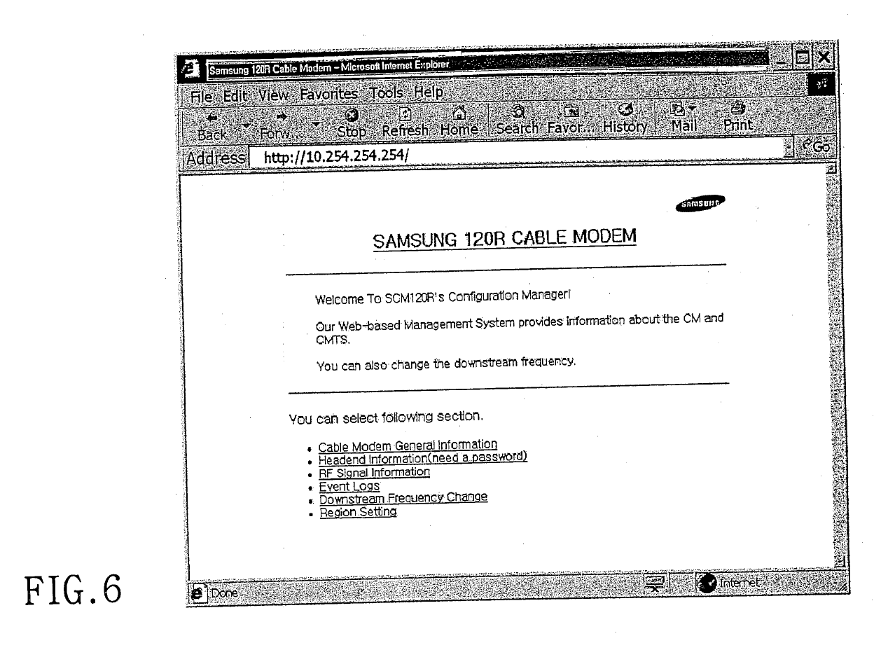

FIG. 6 is an exemplary view showing an initial screen to be displayed by a Web browser of a user computer, in accordance with the principles of the present invention. Here, an Internet protocol (IP) address of a cable modem is “10.254.254.254”. A user can select and execute one of function menus such as “Cable Modem General Information”, “Headend Information (needing a password), “RF Signal Information”, “Event Logs”, “Downstream Frequency Change” and “Region Setting”. If the one of function menus is executed, the Web browser displays an execution result on a screen to provide an execution procedure of the function menu.

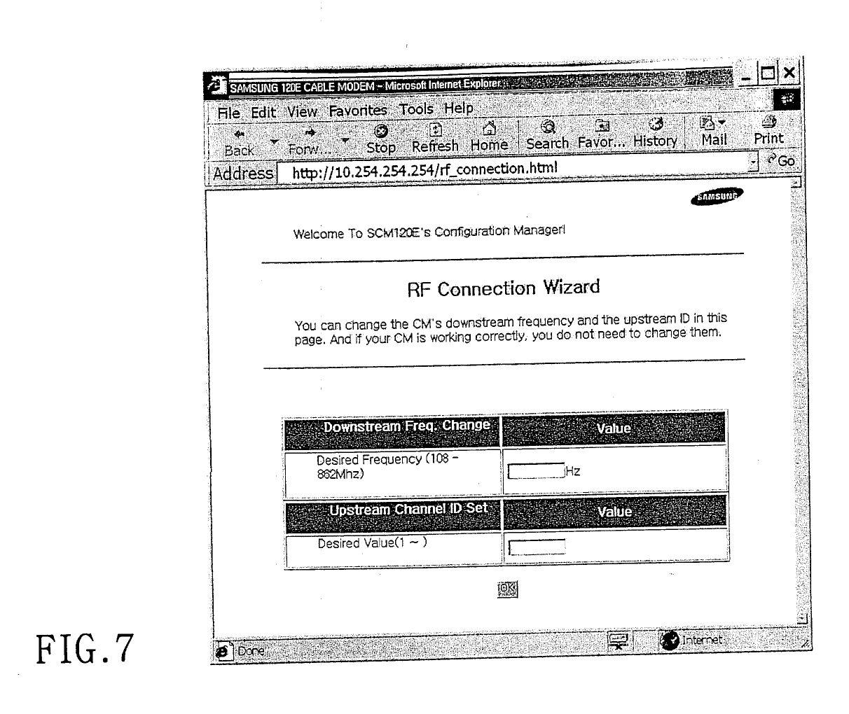

FIG. 7 is an exemplary view showing a screen for setting up operation parameters of a cable modem to be displayed by a Web browser mounted within a user computer, in accordance with the principles of the present invention. As shown in FIG. 7, the Web browser mounted in the user computer can set up a downstream frequency and an upstream channel ID (identifier).

Although the preferred embodiments of the present invention have been disclosed for illustrative purposes, those skilled in the art will appreciate that various modifications, additions and substitutions are possible, without departing from the scope of the invention. For example, although a configuration and operation for mounting a Web browser on a user computer connected to a cable modem and managing a state of the cable modem through the user computer have been disclosed, those skilled in the art will appreciate that the Web browser can be mounted on any computer capable of being connected to the Internet and the state of the cable modem can be managed through the computer.

As apparent from the above description, a user computer or a manager computer in accordance with the present invention can identify operation parameters, which are currently set, and management information of a cable modem by directly managing the cable modem using a hyper text transfer protocol (HTTP) protocol based on the Web without using an additional management protocol such as an SNMP.

Where a problem is caused in a radio frequency (RF) network and a user cannot have an access to the Internet, the present invention allows a user to resolve the problem by setting up the operation parameters using a dynamic host configuration protocol (DHCP) server embedded in the cable modem as a device capable of communicating with the cable mode. By doing this, the present invention can reduce time and costs needed for resolving the problem, compared to other problem solving schemes requiring that a technician or repairman schedule an appointment and visit to make an on-site repair.

In an embodiment, the above-described steps of the present invention can be instructions stored in a memory, and the instructions stored in the memory can be performed by one or more computers. The memory could be any kind of computer memory such as floppy disks, conventional hard disks, removable hard disks, compact discs (CDs), digital versatile discs (DVDs), flash read only memory (flash ROM), nonvolatile read only memory, and random access memory (RAM), for example.

A software implementation of the above-described embodiment may comprise a series of computer instructions either fixed on a tangible medium, such as a computer readable media, for example a compact disc or a fixed disk, or transmissible to a computer system via a modem or other interface device over a medium. The medium can be either a tangible medium, including, but not limited to, optical or analog communications lines, or may be implemented with wireless techniques, including but not limited to microwave, infrared or other transmission techniques. The medium may also be the Internet. The series of computer instructions embodies all or part of the functionality previously described herein with respect to the invention. Those skilled in the art will appreciate that such computer instructions can be written in a number of programming languages for use with many computer architectures or operating systems. Further, such instructions may be stored using any memory technology, present or future, including, but not limited to, semiconductor, magnetic, optical or other memory devices, or transmitted using any communications technology, present or future, including but not limited to optical, infrared, microwave, or other transmission technologies. It is contemplated that such a computer program product may be distributed as a removable media with accompanying printed or electronic documentation, for example, shrink wrapped software, pre-loaded with a computer system, for example, on system read only memory or fixed disk, or distributed from a server or electronic bulletin board over a network, for example, the Internet or World Wide Web.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departing from the spirit or scope of the applicant's general inventive concept.

What is claimed is:

1. An apparatus for managing and controlling a cable modem to enable a computer system to establish an Internet connection, the apparatus comprising:
a cable modem being in communication with a Web browser of a computer system;
a controller managing and setting up management information and operation parameters for operation of said cable modem, said controller being in communication with said cable modem; and
a Web server being connected to said controller, said Web server transmitting the management information provided from said controller to the Web browser in response to a management information request from the Web browser, said Web server transferring an operation parameter setup request from the Web browser to said controller;
said controller changing and setting up the operation parameters of said cable modem in response to the operation parameter setup request.

2. The apparatus of claim 1, said cable modem being connected to a cable line that is connected to Internet, the computer system establishing a connection to the Internet through said cable modem and the cable line when said controller changes and sets up the operation parameters of said cable modem.

3. The apparatus of claim 2, the operation parameters including at least one selected from among a downstream frequency, a downstream modulation scheme, an upstream frequency, an upstream modulation scheme, and a channel associated with said cable modem.

4. The apparatus of claim 3, said Web server receiving the operation parameter setup request in a form of a Web document based on a hyper text transfer protocol (HTTP).

5. The apparatus of claim 4, further comprising a common gateway interface (CGI) performing an interface between said Web server and said controller.

6. The apparatus of claim 4, further comprising an address assigner dynamically assigning an Internet address being identified on the Internet to the computer system in response to an Internet address assignment request from the computer system when the computer system does not have a unique Internet address identified on the Internet.

7. The apparatus of claim 6, said address assigner being a dynamic host configuration protocol (DHCP) server.

8. The apparatus of claim 1, said Web server creating a Web document from the management information provided from said controller to transmit the created Web document to the Web browser based on a hyper text transfer protocol (HTTP).

9. The apparatus of claim 8, said Web server receiving the operation parameter setup request in a form of a Web document based on a hyper text transfer protocol (HTTP).

10. The apparatus of claim 9, further comprising a common gateway interface (CGI) performing an interface between said Web server and said controller.

11. The apparatus of claim 9, further comprising an address assigner dynamically assigning an Internet address being identified on the Internet to the computer system in response to an Internet address assignment request from the computer system when the computer system does not have a unique Internet address identified on the Internet.

12. The apparatus of claim 11, said address assigner being a dynamic host configuration protocol (DHCP) server.

13. The apparatus of claim 12, the operation parameters including at least one selected from among a downstream frequency, a downstream modulation scheme, an upstream frequency, an upstream modulation scheme, and a channel associated with said cable modem.

14. The apparatus of claim 13, said controller and said Web server being installed in said cable modem.

15. The apparatus of claim 14, said cable modem being connected to a cable line that is connected to Internet, the computer system establishing a connection to the Internet through said cable modem and the cable line when said controller changes and sets up the operation parameters of said cable modem.

16. A method for managing and controlling a cable modem to enable a computer system to establish an Internet connection, the method comprising:
sending a first request from a Web browser in a computer system to a Web server in a cable modem, the first request requesting management information associated with an operation of the cable modem;
transmitting the management information from the Web server to the Web browser in response to the management information request;
sending a setup request from the Web browser to the Web server, the setup request requesting operation parameters associated with the operation of the cable modem;
transfering the setup request from the Web server to a controller mounted in the cable modem; and
managing the operation parameters in response to setup request.

17. The method of claim 16, the cable modem being connected to a cable line that is connected to Internet, the computer system establishing a connection to the Internet through the cable modem and the cable line when the controller changes and sets up the operation parameters of the cable modem.

18. The method of claim 17, the operation parameters including at least one selected from among a downstream frequency, a downstream modulation scheme, an upstream frequency, an upstream modulation scheme, and a channel associated with the cable modem.

19. The method of claim 17, further comprising:
receiving an Internet address assignment request from the computer system when the computer system does not have a unique Internet address identified on the Internet; and
assigning an Internet address to the computer system in response to the Internet address assignment request.

20. The method of claim 19, said receiving of the Internet address assignment request and said assigning being performed by an address assigner, the address assigner being a dynamic host configuration protocol (DHCP) server in the cable modem.

21. A method for managing and controlling a cable modem to enable a computer system to establish an Internet connection, the method comprising:
transmitting an Internet address assignment request from a computer system to a cable modem;
assigning an uncertified Internet address on the Internet to the computer system, said assigning being performed by the cable modem;
connecting a Web browser mounted in the computer system to a Web server mounted in the cable modem based on the assigned uncertified Internet address;
transmitting transmit a setup request from the Web browser to the Web server, the setup request requesting operation parameters for operation of the cable modem;
changing and setting up the operation parameters in response to the operation parameter setup request, said changing and setting up being performed by the cable modem;
transmitting a change and setup result through the Web server to the Web browser; and
displaying the change and setup result, said displaying being performed by the Web browser and the computer system.

22. The method of claim 21, the cable modem being connected to a cable line that is connected to Internet, the computer system establishing a connection to the Internet through the cable modem and the cable line when said changing and setting up is performed.

23. The method of claim 22, said transmitting of the Internet address assignment request from the computer system to the cable modem being performed by a dynamic host configuration protocol (DHCP) client in the computer system.

24. The method of claim 23, said assigning being performed by a dynamic host configuration protocol (DHCP) server in the cable modem.

25. The method of claim 24, said changing and setting up being performed by a controller in the cable modem.

26. The method of claim 25, said transmitting of the change and setup result through the Web server to the Web browser further comprising:
transmitting the change and setup result from the controller to the Web server;
creating a Web document from the change and setup result, said creating being performed by the Web server, the Web document being based on a hyper text transfer protocol (HTTP); and
transmitting the Web document from the Web server to the Web browser.
